(19) United States
(12) Patent Application Publication
(10) Pub. No.: US 2024/0161862 A1
(43) Pub. Date: May 16, 2024

(54) SMART MECHANICAL METAMATERIALS WITH TUNABLE STIMULI-RESPONSIVE EXPANSION COEFFICIENTS

(71) Applicant: Northeastern University, Boston, MA (US)

(72) Inventor: Yaning Li, Durham, NH (US)

(21) Appl. No.: 18/280,593

(22) PCT Filed: Mar. 9, 2022
(86) PCT No.: PCT/US22/19432

§ 371 Date: Sep. 6, 2023

Related U.S. Application Data
(60) Provisional application No. 63/158,616, filed on Mar. 9, 2021.

(51) Int. Cl. G12B 1/02; B33Y 80/00

(52) U.S. Cl. CPC G12B 1/02; B33Y 80/00

(57) ABSTRACT

Hybrid structured materials are composed of hard cell structures connected by soft components such as soft networks, soft hinges, or bilayer joints. The soft components are responsive to external stimuli such as mechanical loads, temperature changes, humidity, and electric-magnetic fields. Due to the structural design and responsive properties of the soft components, the structured materials have a wide range of tunable expansion coefficients, including both positive expansion coefficients and negative expansion coefficients. The expansion can be induced by the external stimuli. Depending on the stimuli, the expansion coefficients can be thermal expansion coefficients (CTE), coefficients of moisture expansion (CME), etc.

### CROSS REFERENCE TO RELATED APPLICATIONS

This application claims priority from U.S. Provisional Patent Application No. 63/158,616 filed on Mar. 9, 2021 entitled SMART MECHANICAL METAMATERIALS WITH TUNABLE STIMULI-RESPONSIVE EXPANSION COEFFICIENTS, which is hereby incorporated by reference.

### BACKGROUND

The present application relates generally to structured materials having tunable expansion coefficients.

### BRIEF SUMMARY OF THE DISCLOSURE

A mechanical metamaterial structure in accordance with one or more embodiments comprises a plurality of cell structures arranged in a repeating pattern and comprising a given material and a plurality of connective elements connecting the plurality of cell structures. The connective elements comprise a material that is softer than the given material of the plurality of cell structures and is responsive to an external stimulus. The plurality of connective elements connects the plurality of cell structures in an arrangement configured to cause a volume expansion or contraction of the mechanical metamaterial structure when the external stimulus is applied to the connective elements.

### BRIEF DESCRIPTION OF THE DRAWINGS

FIG. 1A shows schematics of a conventional square lattice structure and deformation pattern. FIG. 1B shows schematics of a square lattice structure in accordance with one or more embodiments with hard square rings and deformation pattern. FIG. 1C shows experimental images of the deformation of the conventional (left) and new (right) square lattices. FIG. 1D shows load-displacement curves of the conventional square lattice (left) and load-displacement curves and area ratio vs. displacement curves of new square lattice (right).

FIGS. 2A-2E show finite element (FE) simulation results for a parametric study. FIG. 2A shows a buckling mode from mode I to mode II. FIG. 2B is a graph showing a critical strain ε_{cr}/(t/L)² vs. stiffness ratio curve (lines represents theoretical prediction and symbols represent FE simulation results). FIG. 2C is a graph showing a strain energy of soft and hard materials over total strain energy vs. stiffness ratio curve. FIG. 2D is a graph showing a strain energy of soft material vs. stiffness ratio curve (line represents theoretical prediction and symbols represent FE simulation results). FIG. 2E is a graph showing a strain energy of hard material vs. stiffness ratio curve (line represents theoretical prediction and symbols represent FE simulation results).

FIGS. 3A-3C show experimental and FE results of snap-shots of the deformed configuration at different overall strains (left) and the curves of load-displacement; angle of soft cells p vs. displacement δy of three displacement ratios: d₁/d₂=1:1 (FIG. 3A), d₁/d₂=1:2 (FIG. 3B), and uniaxial compression (FIG. 3C).

FIGS. 4A-4E show FE simulation results for different biaxial compression displacement ratios. FIG. 4A shows a max in-plane principal strain vs displacement ratio curve before buckling and FE simulation contour of four cases. FIG. 4B shows a max in-plane principal strain vs displacement ratio curve after buckling and FE simulation contour of four cases. FIG. 4C shows a max in-plane principal strain vs displacement ratio curve of original square lattices with hard rings (solid line) and modified square lattices with soft hinges (dash line). FIG. 4D shows a critical strain vs. displacement ratio curve. FIG. 4E shows examples of different designs of the soft connections in accordance with one or more embodiments.

FIG. 5 shows prototypes of shape memory square lattice with two designs: (a) from an expanded shape (shown several stripes) to a compressed shape (shown several circles) and (b) from a compressed shape (shown several circles) to an expanded shape (shown several stripes).

### DETAILED DESCRIPTION

Various embodiments disclosed herein relate to mechanical metamaterials, which are hybrid structured materials composed of hard cells or inclusions connected via specially designed soft components such as soft networks, soft hinges, or bilayer joints. The soft components are responsive to external stimuli such as mechanical loads, temperature changes, humidity, and electric-magnetic fields etc. Due to the special design and responsive properties of the soft components, this family of structured materials can have tunable expansion coefficients in a very wide range, including both positive expansion coefficients and negative expansion coefficients. The expansion can be induced by temperature, humidity, and electric-magnetic fields etc. Based on different types of stimuli, the corresponding expansion coefficients can be thermal expansion coefficients (CTE) and coefficients of moisture expansion (CME), etc.

Exemplary applications of the mechanical metamaterials include sensors, actuators, bio-medical materials and devices, smart digital displays, and smart clothes and wearable devices. The materials can also be used for inducing color change (e.g., for camouflage) and pattern change (e.g., where pattern changes indicate information). In addition, the materials can be used as part of responsive filters or valves to control the flow of fluids or particles.

The mechanical metamaterials can be made using low cost, simple, and versatile manufacturing methods.

The hybrid structured materials can be designed to effectively tune the expansion coefficients of a wide range of materials.

Prototypes of selected designs were fabricated via a multi-material 3D printer. Through mechanical experiments on the 3D printed prototypes, it was shown that upon mechanical instability, the materials can experience dramatic volume change. It was also found that there is an optimized bi-axial displacement ratio that can most easily trigger the volume change.

Through another set of experiments on the 3D printed prototypes, it was also shown that besides mechanical instability, the volume change can also be triggered by the change in temperature. By varying the design and loading process, both positive and negative thermal expansion coefficients can be achieved.

The new mechanical metamaterials have wide range of applications including, e.g., in new sensors, actuators, fasteners, bio-medical materials and devices for drug delivery, bio-medical stents, smart digital displays, smart clothes, and wearable devices etc. It can also be used for inducing color change for camouflage, and pattern change and different patterns can carry different information. In addition, it can be used for designing responsive filters or valves to control the flow of fluids or particles.

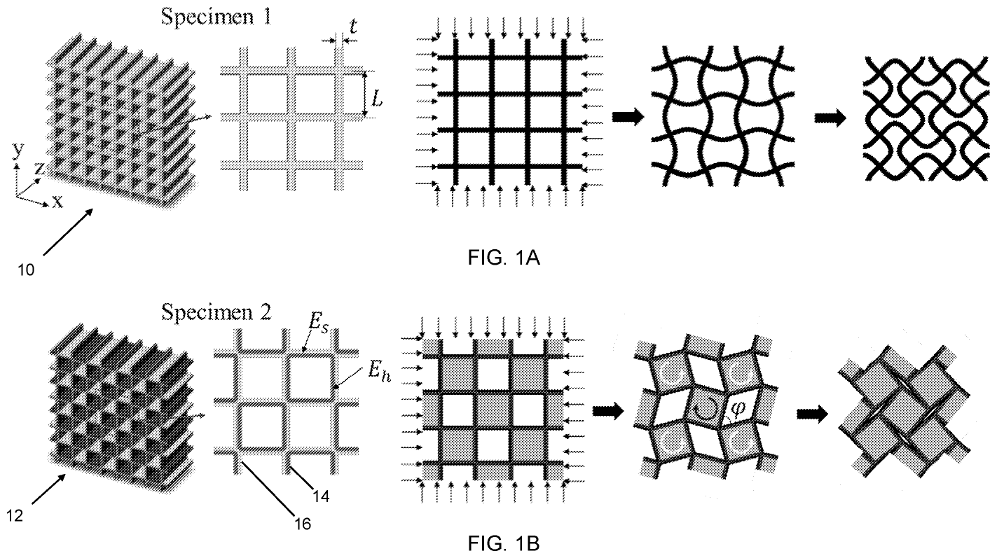

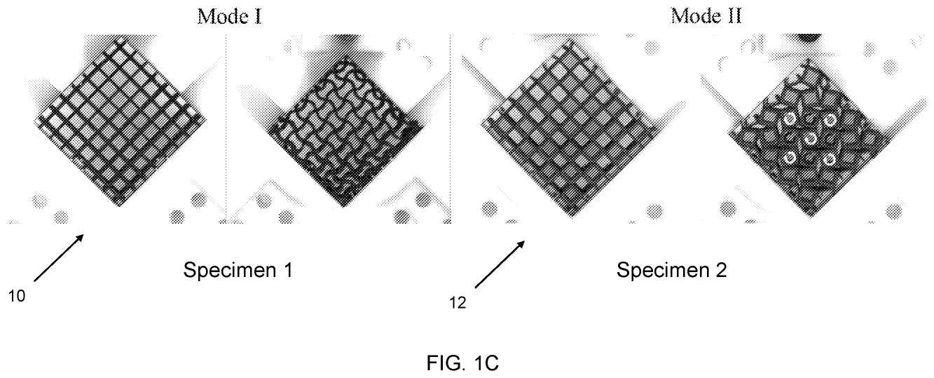

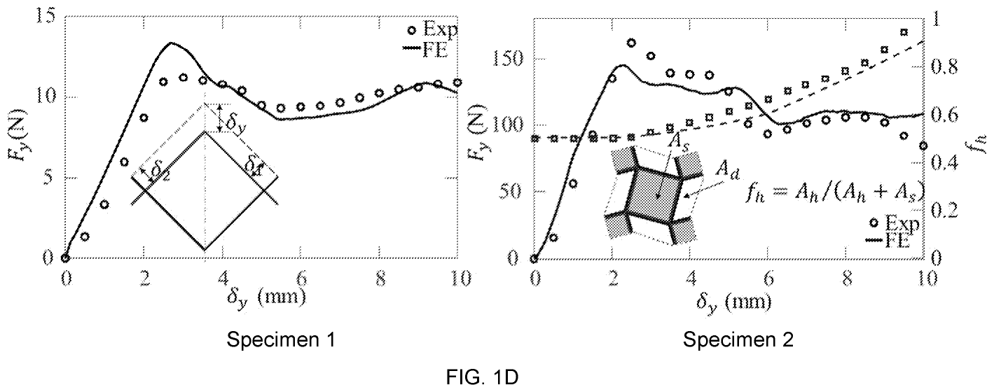

FIGS. 1A and 1B show a comparison of two different 2D square lattices. FIG. 1A shows a square lattice structure 10 made of single material (Design/Specimen 1). FIG. 1B shows a square lattice structure 12 in accordance with one or more embodiments made of two materials with a harder material 14 occupying half of the wall thickness of every other square cell (Design/Specimen 2), forming a pattern of alternating stiffer square rings connected by softer square mesh 16. Both designs have the same rib-length L and wall thickness t (FIGS. 1A and 1B). The Young's modulus of the soft phase is E_{S} and that of the hard phase is Eₕ. The stiffness ratio of the two phases is defined as n=Eₕ/E_{S}.

Both designs were fabricated via a multi-material 3D printer (Objet Connex 260). Design 1 was printed with single material DM9760 (shear modulus ˜0.92 MPa). For Design 2, the soft phase was printed as TangoBlack+(shear modulus ˜0.26 MPa) and the hard phase was printed as VeroWhite (Young's modulus ˜2 GPa, Poisson's ratio ˜0.35, shear modulus ˜740.74 MPa). The overall dimensions of both specimens are 50 mm, 50 mm, and 20 mm along x, y, and z directions, respectively. The total in-plane (x-y plane) thickness t of the walls is 1 mm. The rib length L is 6.25 mm. Thus, there are 8 by 8 square cells in both specimens. For Specimen 2, the thickness of the hard square is t/2.

To explore the mechanical behavior of the two specimens under bi-axial compression loads, a custom bi-axial compression apparatus was mounted on a Zwick material testing machine. The specimens sit in the compression frame of the apparatus. Displacement controlled quasi-static compressive loading was applied (with the loading rate of ˜0.02 mm/s). Under the overall uni-axial compression, the square frame of the apparatus provides bi-axial compression on the specimens. By varying the mounting angle of the square frame in the apparatus, different bi-axial compression ratio can be achieved.

Under bi-axial compression, the structured material will lose stability and different instability patterns will be generated. For the cases of equi-biaxial compression, the instability patterns and the load-displacement curves of the two specimens are shown in FIGS. 1C and 1D, respectively. FIG. 1C shows that for the single material specimen, an achiral wavy pattern is formed with ribs in each cell form a half sinusoidal wave. FIG. 1D shows that for the two-phase specimen, when instability occurs, each hard-square cell rotates, and each soft square cell shear into a diamond shape. The neighboring hard cells rotate in different directions. Eventually, all hard-square cells squeeze together and the soft cells fully close. The peaks on the load-displacement curves of both specimens represent the onset of instability. After reaching the peak, a plateau forms in the post-instability range. For Specimen 2, the volume fraction fₕ framed by the hard-square cells were plotted as a function of the overall compression. In which fₕ is defined as fₕ=Aₕ/(Aₕ+Aₛ) where, Aₕ and Aₛ are the volumes framed by the hard cells and soft cells, respectively. After instability, fₕ changes rapidly from 0.5 to 1, indicating the closing of the soft cells. The experimental results and FE simulation results shows good consistency.

To further understand the mechanics of the pattern transformation from achiral (single material design) to chiral (two-phase design) ones, a two dimensional finite element (FE) model of Design 2 was set up, in which the rib length and the shear modulus of the soft phase are kept the same (L=6.25 mm, ps=0.26 MPa). While, the shear modulus of the hard phase was varied from 0.26 MPa to 1040 MPa with n varies as 1, 2, 4, 6, 10, 15, 20, 40, 100, 400, 1000, and 4000. When n=1, Design 2 degenerates into Design 1. The wall thickness t varies as 0.5, 1, and 2 mm, thus L/t changes as 12.5, 6.25, and 3.125, respectively. The wall thickness of the hard phase is kept as t/2. Therefore, for this parametric study, total 36 FE simulations were performed by systematically varying the geometric and material parameters.

In this parametric study, we focus on exploring the influences of the stiffness ratio n and the length respect ratio L/t of the cell wall on the critical strain to instability and strain energy distribution in two phases. To exclude the boundary effects and get the intrinsic mechanical properties of the material, periodic boundary conditions were used in all FE simulations. Equal biaxial compression loads were applied at the boundaries.

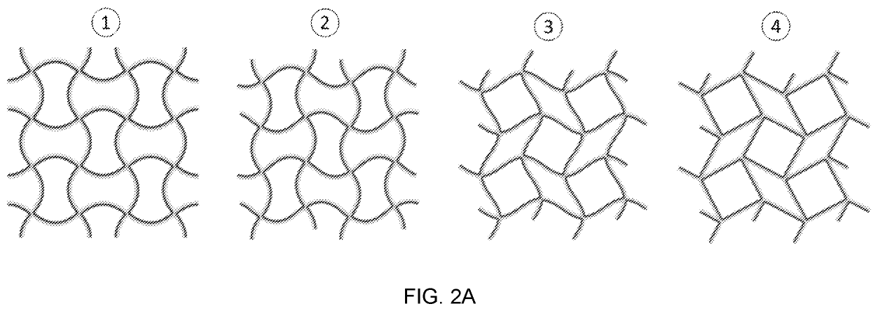

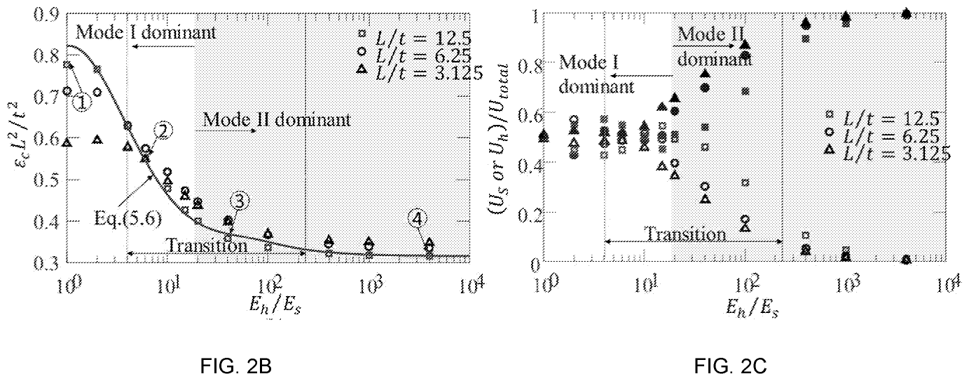

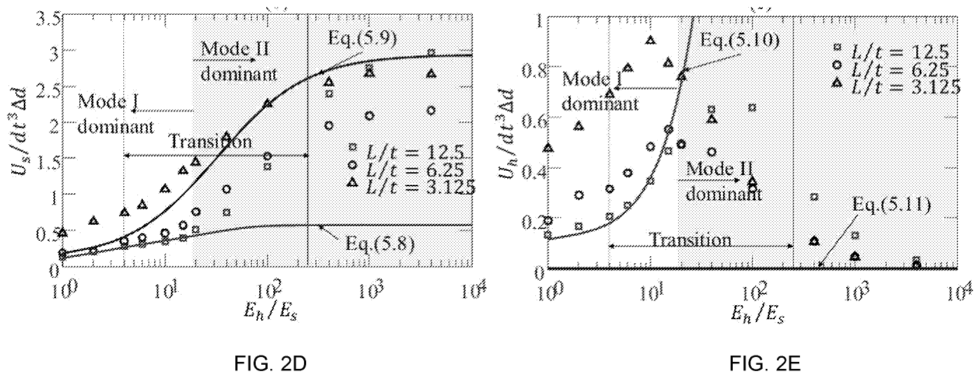

The FE results of the buckling modes of four cases (n=1, 6, 40, and 4000, L/t=12.5) are shown in FIG. 2A. It can be seen that when n=1, the instability mode of is the achiral pattern (Mode I) observed in the experiment on Specimen 1; and when n goes to infinity (n=4000), the instability mode is the rotating square type of pattern (Mode 2) observed in the experiment on Specimen 2. When n changes in between, the instability patterns are a mix of the two modes.

Also, the non-dimensionalized critical strain along y direction is plotted as a function of stiffness ratio n in FIG. 2B. Roughly speaking, when n<15, although the pattern is a combination of both modes, Mode I is dominant; when n>15, Mode II is dominant. For the non-dimensionalized critical strain, both the FE results (square marks for L/t=12.5; circle marks for L/t=6.25; triangle marks for L/t=3.125) and the theoretical predication (solid line) are plotted in FIG. 2B. The theoretical predication of the critical strain is derived from Euler Bernoulli beam theory

$${ε}_{cr} = \frac{2 ( ( \frac{1}{96} + \frac{1}{8 {( 1 + 1 / n )}^{2}} ) + n ( \frac{1}{96} + \frac{1}{{B ( 1 + n )}^{2}} ) )}{( 1 + n )} {( \frac{π t}{KL} )}^{2} , \qquad ( 1 )$$

where K is the column effective length factor depending on n. When the beam has the pin-pin boundary condition, K=1, which is the case for n=1. When n increases, more constraints were introduced to the ends of the beam, therefore K decreases.

From the numerical results, an empirical relation between the K and n is obtained,

$$lg ( \frac{K - {K}_{11}}{{K}_{1} - {K}_{11}} ) = C ( n - 1 ) , \qquad ( 2 )$$

where, K₁ and K₁₁ are the K values of the mode I and model II instability mode, respectively. K₁=1 in this study and K₁ is obtained through FE simulations. C is a coefficient to best fit the numerical results. C=−0.018 in this study.

Eq. 5.6 shows that the critical strain is proportional to the square of (t/L)². Thus, the critical strain can be non-dimensionalized as ε_{cr}/(t/L)²), which theoretically, is only a function of n as shown in FIG. 2B. It shows that the non-dimensionalized critical strain decreases when the stiffness ratio n increases. For mode I, the value of ε_{cr}/(t/L)² is 0.8 and decreases significantly when n increases beyond 15. After n becomes larger than 15, the value of ε_{cr}/(t/L)² only decreases slightly and becomes asymptotic to ˜0.32. In the range for Mode I, the numerical results of the non-dimensionalized critical strain depends on L/t, although theoretically it should be independent on L/t. This discrepancy is because that the Euler Bernoulli beam theory only holds for large L/ts. For relative small L/ts, the theory is no longer accurate.

To quantify the energy distribution in the soft and hard phases in the post-instability range, the numerical results of the strain energy in the soft and hard phases are output at the same overall displacement (3 mm) after the instability. For the two different modes, the strain energies in soft and hard phases are derived as

$${U}_{s}^{I} = \frac{4 {π}^{2} {dt}^{3} Δ d}{{K}^{2} {L}^{2}} ( \frac{1}{96} + \frac{1}{8 {( 1 + 1 / n )}^{2}} ) {E}_{s} \qquad ( 3 )$$

$${U}_{h}^{I} = \frac{4 {π}^{2} {dt}^{3} Δ d}{{K}^{2} {L}^{2}} ( \frac{n}{96} + \frac{n}{8 {( 1 + n )}^{2}} ) {E}_{s} \qquad ( 4 )$$

$${U}_{s}^{II} = \frac{64 {Cdt}^{3} ( 1 + n ) {E}_{s}}{8 {L}^{2} - 3 tL + 3 tLn} Δ d \qquad ( 5 )$$

$${U}_{h}^{II} = 0 \qquad ( 6 )$$

where Δd is the relative displacement after instability, d is the displacement in y direction.

Equations (3)-(6) show that the strain energy in each phase for each mode is proportional to dt³Δd. Thus, the strain energy U can be non-dimensionalized as U/dt³Δd.

The FE results (square marks for L/t=12.5; circle marks for L/t=6.25; triangle marks for L/t=3.125) and the theoretical predication (red solid line for mode I and blue solid line for mode II) of the non-dimensionalized strain energy in the soft phase and the hard phase are compared in FIGS. 2D and 2E, respectively. It can be seen that for the strain energy in soft phase, it increases slightly when n increases in the Mode I dominant area (left side area in FIGS. 2D and 2E) and start to increase dramatically in the Mode II dominant transition area (left side of the blue dash line in the right side area in FIGS. 2D and 2E). While, it tends to be a constant value in pure Mode II area (right side of the blue dash line in the right side area in FIGS. 2D and 2E).

In Mode I dominant part, the theoretical prediction is based on the Euler beam theory (Equations (3) and (4)). For Mode II dominant part, the theoretical prediction is based on the rotational spring rigid rod model (Equations (5) and (6)). For the strain energy in the hard phase, in the Mode I dominant area, it increases when n increases; after n increases into the Model II dominant area, the rate of increase reduces, and it starts to decease in pure Mode II area and goes to zero for very large value of n, which representing the ideal Mode II. The theoretical prediction based on the Euler beam theory match with the FE results very well in the Mode I dominant area. The theoretical prediction of the strain energy in the hard phase based on the rotational spring rigid rod model give a zero value, since in that model, the hard phase only has rigid body rotation.

To further compare the strain energy distribution in soft and hard material, the strain energy in soft and hard material over the total strain energy Uₛ/Uₜₒₜₐₗ and Uₕ/Uₜₒₜₐₗ, where Uₜₒₜₐₗ=Uₛ+Uₕ are outputted in FIG. 2C (solid marks for soft material and hollow marks for hard material; square marks for L/t=12.5; circle marks for L/t=6.25; triangle marks for L/t=3.125).

It shows that for all cases, the value of the energy ratio is ˜0.5 for both soft and hard material in Mode I dominant area. After n increases into Mode II dominant area, the energy ratio of soft material (solid marks) starts to increase and that of hard material (hollow marks) starts to decrease significantly, presenting a bifurcation in the area of transition from Mode I to Mode II. This bifurcation indicates that for Mode I pattern, the energy distribution is almost the same in soft and hard material since bending occurs in both hard and soft phases. When transit to Mode II, the energy will distribute more into soft phase. This is because that the bending in the ribs reduces while rotation of the cell increases, and then the rotation-induced strain starts to localize in the soft phase.

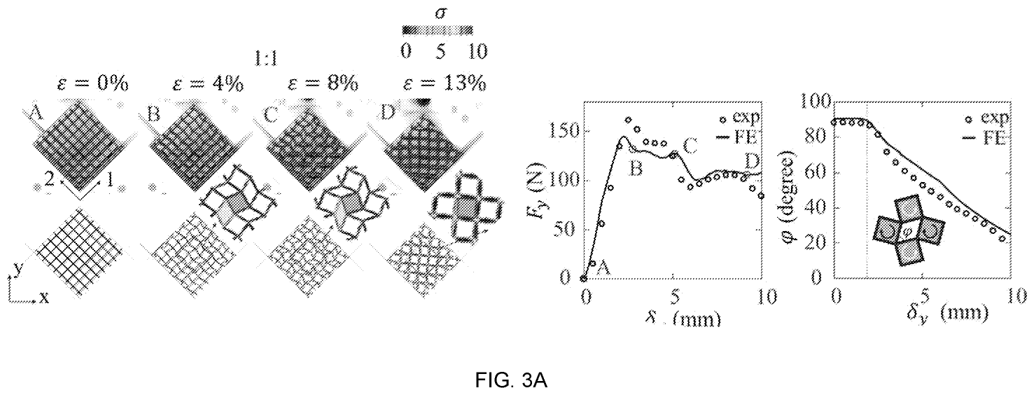

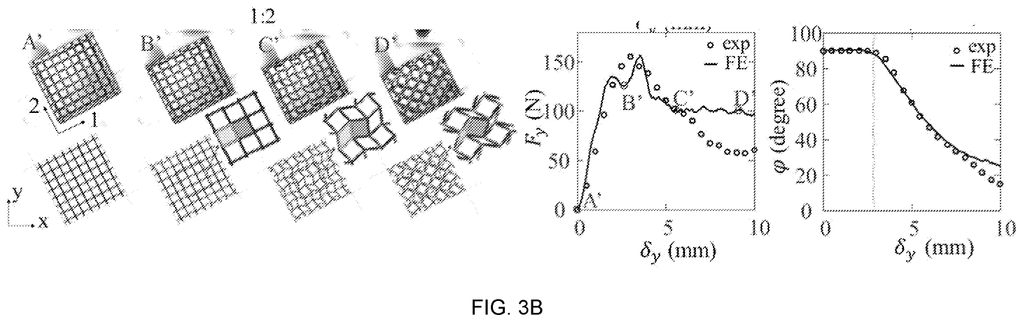

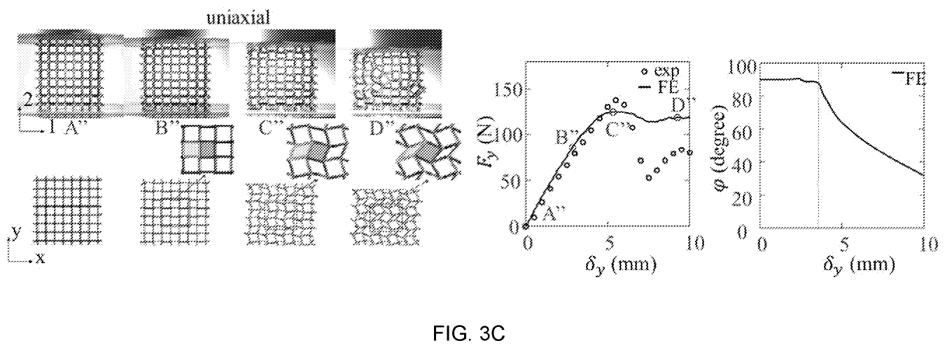

The custom bi-axial apparatus can achieve a different displacement ratio by rotating the loading frame and mounting it on corresponding channels. By using the custom bi-axial compression apparatus, mechanical experiments under different displacement ratios were performed on Specimen 2. The displacement ratio is defined as d₁/d₂, where d₁ and d₂ are the displacement along local directions 1 and 2, respectively. In the experiments, three loading cases were explored: biaxial compression with d₁/d₂=1 and 2, and uniaxial compression. For each experiment, FE simulations were performed, in which, the load frame of the biaxial apparatus was represented by an analytical rigid surface with a right angle, hard contact was defined between the surface the boundaries of the specimen. The experimental and FE results of the three cases are shown in FIG. 3.

FIGS. 3A-3C show that for both bi-axial cases of d₁/d₂=1:1 and 1:2, the square cells with hard phase eventually all squeeze together form a compact pattern. While for the case of uniaxial compression, local failure occurs upon instability and the collapsed hard square cells form a shear band. There are some differences between these three cases. For the case of d₁/d₂=1:1, the hard square cells maintain the prefect square during rotation. While for the case of d₁/d₂=1:2 and uniaxial compression case, the hard square cells deform into rectangular cells.

The displacement-force curves of the three cases are plotted in FIGS. 3A, 3B, and 3C. It can be seen that for all three cases, the curves are linear before the peak load. When instability occurs, the load reaches the peak and after instability, the force drops gracefully. The equi-biaxial case has the smallest indentation travel before instability, and the uniaxial case has the largest indentation travel before instability, indicating the equi-biaxial loading is the easiest loading case to trigger the instability-induced pattern. All three cases have very similar peak load ˜150N. Generally, the FE results are consist with the experimental results for all three cases. There are some discrepancy between FE and experimental data, especially after instability for the uniaxial case and the case of d₁/d₂=1:2. This is because that in experiments, damage occurs, while in the FE simulations, it was assumed that there is no damage in the materials.

To exclude the boundary effects and get the intrinsic mechanical properties of the material, FE simulations with periodic boundary conditions were performed under different biaxial displacement ratio. Seven different biaxial displacement ratios and one uniaxial compression were applied in the FE simulations. For all FE models, the stiffness ratio of 1000 was used.

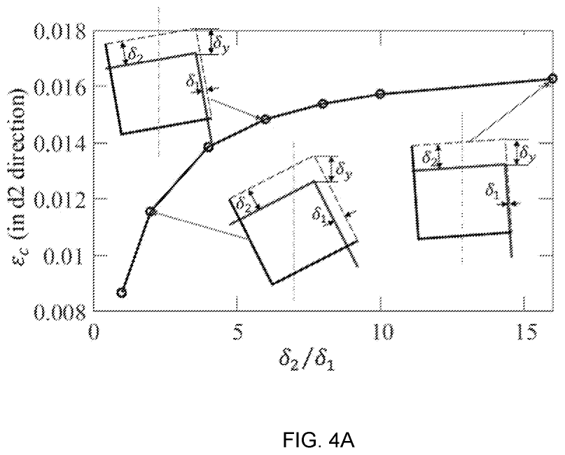

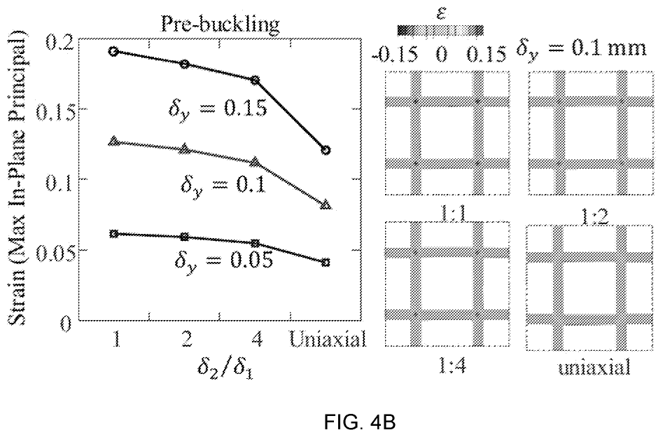

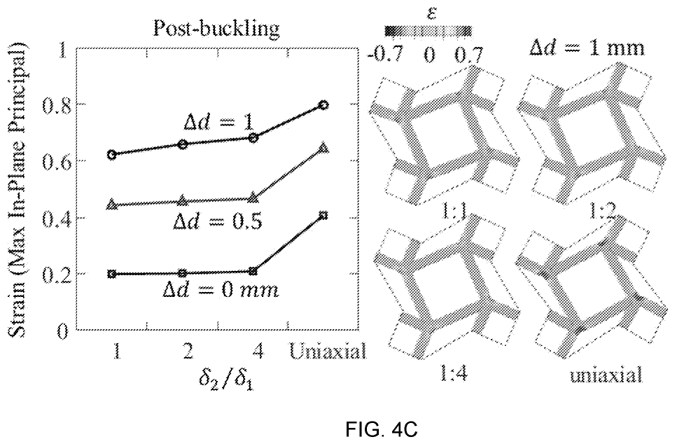

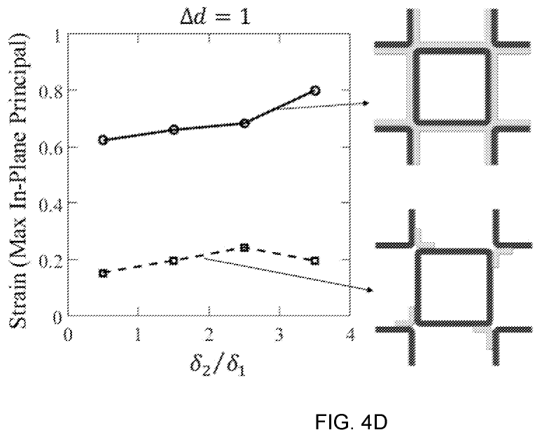

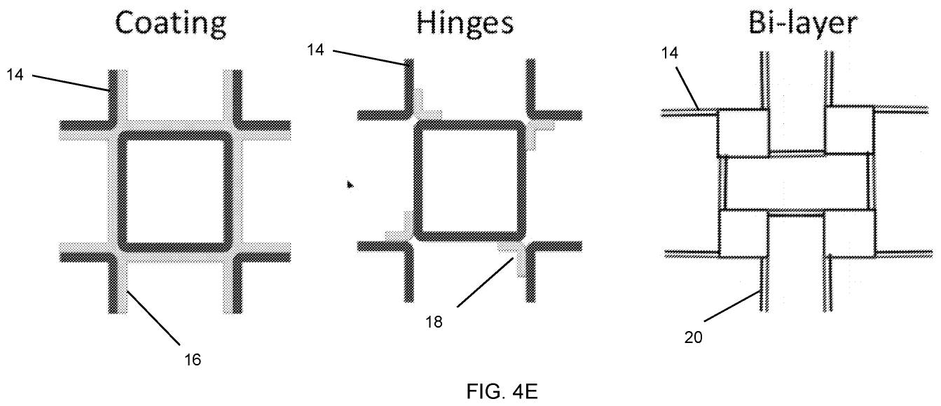

The FE results of the critical strain are plotted as a function of bi-axial displacement ratio, as shown in FIG. 4D. It can be seen that when the displacement ratio increases, the critical strain increases. This result is consistent with the results in FIGS. 3A-3C.

The local deformation within the lattices before and after instability are quantified from the FE simulations. The max in-plane principal strain of the four FE models (d₁/d₂=1:1, 1:2, 1:4 and uniaxial compression) are compared in both pre-instability and post-instability ranges at different overall displacement δy; as shown in FIGS. 4A and 4B. It can be seen that in the pre-instability range (FIG. 4A), the max in-plane principal strain increases when displacement δy increases for all four cases. At same displacement δy for all three (δy=0.05 mm, 0.1 mm, and 0.15 mm), when the displacement ratio increases, due to the increase in constrains, the max in-plane principal strain decreases.

However, in the post-instability range (FIG. 4B), the trend of the influences of bi-axial displacement ratio on the local strain is opposite to that in the pre-instability range. It can be seen that when the bi-axial displacement ratio increases, the max in-plane principal strain increases for all different Δd values, where Δd is the relative displacement after instability (Δd=0 represents the onsite of instability and Δd=0.5 mm represents that δy increases 0.5 mm after instability).

The contour of max in-plane principal strain for the four cases before instability (δy=0.1 mm) and after instability (Δd=1 mm) show that before instability, the uniaxial compression case has the lowest local compressive strain. However, after instability, the uniaxial compression case has the highest tensile strain.

The trends shown in the pre-instability range and in the post-instability range are consistent with those shown in the experiments (FIG. 3), in which the uniaxial compression load is the most difficulty loading case to trigger the instability-induced pattern transformation and the worst loading case to damage the specimen in the post-instability range; on the contrary, the equi-biaxial loading case is the easiest loading case to trigger the instability-induced pattern transformation and the best loading case to avoid local failure in the specimen.

FIG. 4B shows that for all cases, the largest local strain is located at the corner of the soft square cells. This local strain can cause damage before the fully development of the pattern. In order to reduce the local strain and facilitate the formation of the instability-induced pattern, a modified design is showed in FIG. 4C, in which, hard square cells are connected only though soft hinges at the corners of two neighboring cells. It can be seen that with this modification, the max in-plane principal strain is reduced to less than ⅓ of the original design. Also, with this modification, the pattern starts to form immediately upon external loads, and no obvious instability is observed.

The pattern transformation can be triggered by not only mechanical instability, but also by external stimuli, such as temperature. For example, if the soft hinges are made of materials with shape memory effects, the pattern transformation can be triggered by temperature change.

Also, the soft connection can have different designs, as shown in FIG. 4E. FIG. 4E shows three types of designs: soft network 16, soft hinges 18, and a bi-layer network 20. The first two designs are utilizing the shape memory effects of the soft materials, and the third design uses the mismatch of the expansion coefficients of the two different layers and therefore the change in curvature of the bi-layer upon changes in temperature, moisture and/or electric-magnetic fields.

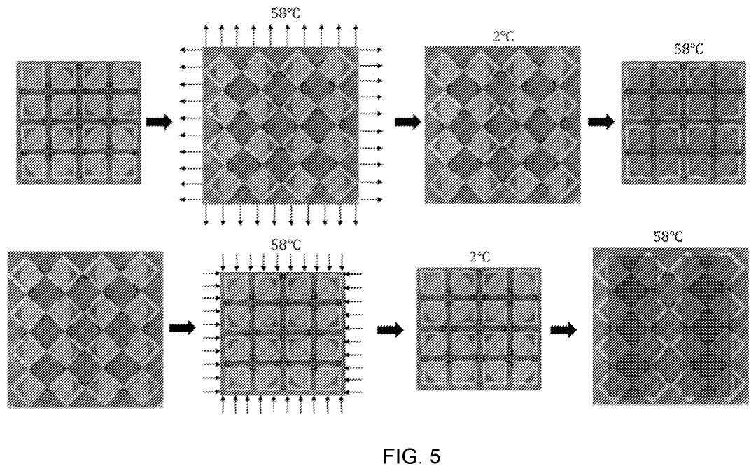

In one or more embodiments, the materials from the 3D printer have shape memory effects. To demonstrate the pattern transformation through temperature change, specimens (with the modified design shown in FIG. 4C) were fabricated with the multi-material 3D printer, in which, the hard square cells were printed as VeroWhite (glass transition temperature Tg≈60° C., and the soft hinges were printed as DM9870 glass transition temperature 2°<Tg<8°). One specimen (Specimen A in FIG. 5A) was designed and 3D printed in a fully closed configuration, and the other (Specimen B in FIG. 5B) was designed and 3D printed in a fully extended configuration. For better visualization of the pattern, one quarter circle is designed in each hard square cell, therefore, when the cells fully close, four quarter circles from the four neighboring cells will rotate into a full circle.

First, both specimens are put into a tank of hot water with the temperature of 58° C., which is above the glass transition temperature of the soft hinge material. Under this temperature, the soft hinges become extremely soft. The samples were then deformed under equi-biaxial tension (Specimen 1, FIG. 5A) or compression (Specimen 2, FIG. 5B). The loads were hold and at the same time water temperature was reduced to 2° C., which is below the Tg of soft hinge material. After the load is removed, the water temperature is changed back to 58° C. again. Thus, due to the shape memory effects of the soft hinges, the deformed specimens go back to their original configuration. It can be seen that for Specimen 1, the quarter circles in hard square cells rotate and form circles (marked in red), while for Specimen 2, the quarter circles in hard square cells rotate and form strips (marked in blue).

Mechanical experiments on the 3D printed specimens were performed under quasi-static (with overall strain rate 10⁻³ per second) biaxial compressive loading. To allow full curing, all specimens were tested 24 hours after printing under room temperature. The experiments were conducted on a Zwick/Roell material testing machine (ZwickiLine) mounted with custom biaxial compression apparatus. The custom biaxial compression apparatus can achieve different biaxial displacement ratio by simply rotate the loading frames and matching them with paired channels. A high-resolution camera was used to record the deformed configurations of the specimens at each time instant during the experiments. Image processing was performed to output data from the images taken.

Finite element simulations of the experiments. FE simulations of the biaxial compression experiments on the two specimens were performed in ABAQUS/STANDARD V6.13. Four-node 2D plane stress elements (CPS4) were used and the accuracy was verified by mesh refinement study. Since the hard square cells in specimens barely deform during deformation, linear elastic isotropic material model with Young's modulus E=500 MPa, the Poisson's ratio v=0.35, was used (measured from standard dogbone tests). For rubbery DM9760 and TangoBlack+, incompressible hyperelastic Mooney-Rivlin model was used. The strain energy density function of the Mooney-Rivlin model is W=C₁₀ (l₁−3)+C₀₁ (l₂−3), where l₁ and l₂ are the first and second invariants of Cauthy-Green deformation tensor. The material parameters were obtained from the standard experiments of both uni-axial tension and compression. For DM9760, C₀₁=0.46 MPa, C₁₀=OMPa, (in the true strain range of ˜−0.8 to 0.4). For TangoBlack+, take the consider of the interphase at the boundary of two different materials due to the material jetting process of the 3D printer C₀₁=0.1208 MPa, C₁₀=0. 3792 MPa, (in the true strain range of ˜−0.8 to 0.4). Two rigid surfaces with right-angles were modelled to represent the biaxial compression apparatus and contact were defined between the specimen and the rigid surfaces. The bottom surface was fixed and prescribed displacement were added on the top surface to represent the biaxial compression process of the experiments. For the one uniaxial compression case, two rigid flat surfaces were modelled to represent the compression disks. Contact was defined between the rigid surfaces and the FE model. The bottom surface was fixed and prescribed displacement was added at the top surface to represent the uniaxial compression process of the experiments.

FE simulations of parametric study. FE simulations of the parametric study were performed in ABAQUS/STANDARD V6.13. The RVE was modelled with four-node 2D plane stress elements (CPS4) and the accuracy was verified by mesh refinement study. Periodic boundary condition was applied at all four edges of the FE model to exclude the boundary effects. Prescribed displacement was applied on the dummy point to perform bi-axial compression.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Δdditionally, elements and components described herein may be further divided into additional components or joined together to form fewer components for performing the same functions.

Accordingly, the foregoing description and attached drawings are by way of example only, and are not intended to be limiting.

1. A mechanical metamaterial structure, comprising:
a plurality of cell structures arranged in a repeating pattern and comprising a given material; and
a plurality of connective elements comprising a material that is softer than the given material of the plurality of cell structures and is responsive to an external stimulus, the plurality of connective elements connecting the plurality of cell structures in an arrangement configured to cause a volume expansion or contraction of the mechanical metamaterial structure when the external stimulus is applied to the connective elements.

2. The mechanical metamaterial structure of claim 1, wherein the mechanical metamaterial structure comprises a square lattice structure.

3. The mechanical metamaterial structure of claim 1, wherein the connective elements comprise soft hinges connecting each of the plurality of cell structures to adjacent cell structures.

4. The mechanical metamaterial structure of claim 1, wherein the connective elements form a layer on outer surfaces of the cell structures.

5. The mechanical metamaterial structure of claim 1, wherein the external stimulus comprises a mechanical load, a temperature change, a humidity change, or an electric-magnetic field.

6. The mechanical metamaterial structure of claim 1, wherein the mechanical metamaterial structure has a tuned positive or negative expansion coefficient based on the materials of the cell structures and connective elements or the shape of the mechanical metamaterial structure.

7. The mechanical metamaterial structure of claim 1, wherein the mechanical metamaterial structure is configured for use in a sensor, an actuator, a medical device, a bio-medical device or material, a smart digital display, smart apparel, or a wearable device.

8. The mechanical metamaterial structure of claim 1, wherein the mechanical metamaterial structure is configured for inducing color change or pattern change.

9. A method of expanding or contracting a structure, comprising the steps of
providing a mechanical metamaterial structure, comprising a plurality of cell structures arranged in a repeating pattern and a plurality of connective elements connecting the plurality of cell structures, the connective elements comprising a material that is softer than the plurality of cell structures and is responsive to an external stimulus; and
applying the external stimulus is applied to the connective elements to cause a volume expansion or contraction of the mechanical metamaterial structure

10. The method of claim 9, wherein the mechanical metamaterial structure comprises a square lattice structure.

11. The method of claim 9, wherein the connective elements comprise soft hinges connecting each of the plurality of cell structures to adjacent cell structures.

12. The method of claim 9, wherein the connective elements form a layer on outer surfaces of the cell structures.

13. The method of claim 9, wherein the external stimulus comprises a mechanical load, a temperature change, a humidity change, or an electric-magnetic field.

14. The method of claim 9, wherein the mechanical metamaterial structure has a tuned positive or negative expansion coefficient based on the materials of the cell structures and connective elements or the shape of the mechanical metamaterial structure.

15. The method of claim 9, wherein the method is used in a sensor, an actuator, a medical device, a bio-medical device or material, a smart digital display, smart apparel, or a wearable device.

16. The method of claim 9, wherein the mechanical metamaterial structure is configured for inducing color change or pattern change.

17. A mechanical metamaterial structure, comprising:
a plurality of cell structures arranged in a repeating pattern and comprising a given material; and
a plurality of connective elements comprising a material that is softer than the given material of the plurality of cell structures and is responsive to an external stimulus, the plurality of connective elements connecting the plurality of cell structures in an square lattice structure configured to cause a volume expansion or contraction of the mechanical metamaterial structure when the external stimulus is applied to the connective elements, wherein the mechanical metamaterial structure has a tuned positive or negative expansion coefficient based on the materials of the cell structures and connective elements or the shape of the mechanical metamaterial structure.

18. The mechanical metamaterial structure of claim 17, wherein the connective elements comprise soft hinges connecting each of the plurality of cell structures to adjacent cell structures.

19. The mechanical metamaterial structure of claim 17, wherein the connective elements form a layer on outer surfaces of the cell structures.

20. The mechanical metamaterial structure of claim 17, wherein the external stimulus comprises a mechanical load, a temperature change, a humidity change, or an electric-magnetic field.

21. The mechanical metamaterial structure of claim 17, wherein the mechanical metamaterial structure is configured for use in a sensor, an actuator, a medical device, a bio-medical device or material, a smart digital display, smart apparel, or a wearable device.

22. The mechanical metamaterial structure of claim 17, wherein the mechanical metamaterial structure is configured for inducing color change or pattern change.
